(19) United States
(12) Patent Application Publication
(10) Pub. No.: US 2024/0166814 A1
(43) Pub. Date: May 23, 2024

(54) POLYESTERAMIDE RESIN, MANUFACTURING METHOD OF THE SAME, AND BIAXIALLY STRETCHED FILM INCLUDING THE SAME

(71) Applicant: SK CHEMICALS CO., LTD., Gyeonggi-do (KR)

(72) Inventors: Jung-Me MOON, Gyeonggi-do (KR); Kwang Sei OH, Gyeonggi-do (KR); Sin Young HWANG, Gyeonggi-do (KR); Jeoung-Jun HWANG, Gyeonggi-do (KR)

(21) Appl. No.: 18/556,427

(22) PCT Filed: Apr. 28, 2022
(86) PCT No.: PCT/KR2022/006078

§ 371 Date: Oct. 20, 2023

(30) Foreign Application Priority Data
May 7, 2021 (KR) 10-2021-0059158

(51) Int. Cl. C08G 69/44; B29C 55/00; B29C 55/14; C08J 5/18

(52) U.S. Cl. CPC C08G 69/44; B29C 55/005; B29C 55/143; C08J 5/18; B29K 2077/00

(57) ABSTRACT

Provide are a polyesteramide resin, a preparation method thereof, and a biaxially oriented film including the same.

Specifically, provided are a polyesteramide resin, in which a diacid moiety and a diol moiety are introduced together with a diamine moiety, a preparation method thereof, and a biaxially oriented film including the same.

### TECHNICAL FIELD

### Cross-Reference to Related Application

The present application is based on, and claims priority from, Korean Patent Application No. 10-2021-0059158, filed on May 7, 2021, the disclosure of which is hereby incorporated by reference herein in its entirety.

The present invention relates to a polyesteramide resin, a preparation method thereof, and a biaxially oriented film including the same.

### BACKGROUND ART

Polyester resin is a material with excellent mechanical strength, heat resistance, transparency, and gas barrier properties.

A representative example of the polyester resin may be polyethylene terephthalate (PET) obtained by copolymerizing terephthalic acid (TPA) and ethylene glycol (EG), and a biaxially oriented PET film is used in packaging, display, insulating materials, and various industrial fields.

However, since PET has a low melting point (Tm) of 260° C., there is a limitation in that the surface mount technology recently used in the art is applied thereto.

In order to overcome the above limitation of PET, polycyclohexanedimethylene terephthalate (PCT) having a higher Tm has been proposed.

However, homo-PCT is difficult to process into a biaxially oriented film because of its high crystallization rate, and it is common to control the crystallization rate by introducing heterogeneous monomers such as isophthalic acid (IPA), ethylene glycol, etc.

However, PCT into which heterogeneous monomers are introduced has reduced thermal properties such as glass transition temperature (Tg), Tm, etc., as compared to homo-PCT, and has a problem in that it is difficult to increase tensile strength due to a low draw ratio when processed into a biaxially oriented film.

### DISCLOSURE

### TECHNICAL PROBLEM

There are provided a polyesteramide resin with improved heat resistance (particularly, thermal properties such as Tg, etc.) and film properties (particularly, properties such as tensile strength, storage modulus, etc.), as compared to polyester resins commonly known, a preparation method thereof, and a biaxially oriented film including the same.

### TECHNICAL SOLUTION

Specifically, there is provided a polyesteramide resin obtained by copolymerizing a diacid component, a diol component, and a diamine component all together, a preparation method thereof, and a biaxially oriented film including the same.

In particular, the diacid component and the diol component are blended at a specific molar ratio.

### Definition of Terms

As used herein, the ‘moiety’ refers to a certain segment or unit that is derived from a specific compound when the specific compound participates in a chemical reaction and is included in a product resulting from the chemical reaction.

Specifically, in the polyesteramide resin, a ‘moiety’ of the diacid component, a ‘moiety’ of the diol component, and a ‘moiety’ of the diamine component refer to a segment derived from the diacid component, a segment derived from the diol component, and a segment derived from the diamine component, respectively.

### Polyesteramide Resin

In one embodiment of the present invention, provided is a polyesteramide resin including a diacid moiety which is a moiety of a diacid component including terephthalic acid; a diol moiety which is a moiety of a diol component including cyclohexanedimethanol; and a diamine moiety which is a moiety of a diamine component including bis(aminomethyl)cyclohexane, wherein a molar ratio of the diacid moiety and the diol moiety satisfies a specific range.

The polyesteramide resin retains mechanical strength, heat resistance, chemical resistance, etc. due to the diacid moiety, and retains transparency and impact strength due to the diol moiety, while having improved heat resistance (particularly, thermal properties such as Tg, etc.) and film properties (particularly, properties such as tensile strength, storage modulus, etc.) due to the diamine moiety.

In particular, when the diol moiety satisfies 70 mol % to 99 mol %, based on 100 mol % of the diacid moiety, the effects of the diacid moiety and the diol moiety may be realized together and the effect by the diamine copolymerization may be realized, thereby improving the heat resistance and film properties of the polyesteramide resin in balance.

Hereinafter, the polyesteramide resin will be described in detail.

### Diacid Moiety

As described above, with regard to the polyesteramide resin, the ‘moiety’ of the diacid component refers to a segment derived from the diacid component.

The diacid component corresponds to a main monomer that forms the polyesteramide resin through esterification and amidation reactions with the diol component and the diamine component; and a polycondensation reaction.

Specifically, the diacid component includes terephthalic acid, and physical properties of the polyesteramide resin, such as mechanical strength, heat resistance, chemical resistance, etc., may be improved by the terephthalic acid.

The diacid component may further include an aromatic dicarboxylic acid component, an aliphatic dicarboxylic acid component, or a mixture thereof, in addition to terephthalic acid. In this case, the diacid components other than terephthalic acid may be included in an amount of 1 mol % to 20 mol %, based on the total 100 mol % of the moieties of the total diacid components.

The aromatic dicarboxylic acid component may be aromatic dicarboxylic acid having 8 to 20 carbon atoms, specifically, 8 to 14 carbon atoms, or a mixture thereof. Examples of the aromatic dicarboxylic acid may include isophthalic acid, naphthalenedicarboxylic acid such as 2,6-naphthalenedicarboxylic acid, etc., diphenyl dicarboxylic acid, 4,4′-stilbenedicarboxylic acid, 2,5-furandicarboxylic acid, 2,5-thiophenedicarboxylic acid, etc., but specific examples of the aromatic dicarboxylic acid are not limited thereto.

The aliphatic dicarboxylic acid component may be an aliphatic dicarboxylic acid component having 4 to 20 carbon atoms, preferably 4 to 12 carbon atoms, or a mixture thereof. Examples of the aliphatic dicarboxylic acid may include cyclohexanedicarboxylic acid such as 1,3-cyclohexanedicarboxylic acid, 1,4-cyclohexanedicarboxylic acid, etc., linear, branched, or cyclic aliphatic dicarboxylic acid components such as phthalic acid, sebacic acid, succinic acid, isodecylsuccinic acid, maleic acid, fumaric acid, adipic acid, glutaric acid, azelaic diacid, etc., but specific examples of the aliphatic dicarboxylic acid are not limited thereto.

### Diol Component

As described above, with regard to the polyesteramide resin, the ‘moiety’ of the diol component refers to a segment derived from the diol component.

The diol component corresponds to a main monomer that forms the polyesteramide resin through the esterification reaction with the above-described diacid component and the polycondensation reaction.

Specifically, the diol component includes cyclohexanedimethanol (CHDM), which is a component contributing to improving transparency and impact strength of the polyesteramide.

The cyclohexanedimethanol may include one or more selected from the group consisting of 1,2-cyclohexanedimethanol, 1,3-cyclohexanedimethanol, and 1,4-cyclohexanedimethanol (1,4-CHDM). For example, as the cyclohexanedimethanol, 1,4-cyclohexanedimethanol may be used as in Example to described later.

The moiety derived from the diol component in the polyesteramide resin may be included in an amount of 70 mol % to 99 mol %, based on 100 mol % of the diacid moiety.

When the content of the diol moiety is outside the above range, the effect on heat resistance and film properties of the polyesteramide resin may be insignificant.

On the contrary, when the content of the diol moiety satisfies the above range, transparency and impact strength of the polyesteramide resin may be improved. In addition, it is also possible to appropriately control the content of the diol moiety within the above range by considering the desired physical properties of the polyesteramide resin.

For example, the diol moiety in the polyesteramide resin may be included in an amount of 70 mol % or more, 72 mol % or more, 74 mol % or more, 76 mol % or more, 78 mol % or more, or 80 mol % or more, and 99 mol % or less, 98.5 mol % or less, 98 mol % or less, 98.5 mol % or less, or 97 mol % or less, based on 100 mol % of the diacid moiety.

In addition to cyclohexanedimethanol, the diol component may further include ethylene glycol, isosorbide, 1,3-cyclobutanediol, 2,4-dimethylcyclobutane-1,3-diol, 2,4-diethylcyclobutane-1,3-diol, 2,2-dimethylcyclobutane-1,3-diol, 2,2,4,4-tetramethylcyclobutane-1,3-diol, tricyclodecanedimethanol, pentacyclopentadecanedimethanol, decalindimethanol, tricyclotetradecanedimethanol, norbornanedimethanol, adamantanedimethanol, 3,9-bis(1,1-dimethyl-2-hydroxyethyl)-2,4,8,10-tetraoxaspiro[5.5]undecane, bicyclo[2.2.2]octane-2,3-dimethanol, 1,3-cyclohexanediol, 1,4-cyclohexanediol, 2-methyl-1,4-cyclohexanediol, tricyclodecanediol, pentacyclopentadecanediol, decalindiol, tricyclotetradecanediol, norbornanediol, adamantanediol, 2,2-bis(4-hydroxycyclohexyl)propane, 3,3′-spiro-bis(1,1-dimethyl-2,3-dihydro-1H-inden-5-ol), dispiro[5.1.5.1]tetradecane-7,14-diol, 5,5′-(1-methylethylidene)bis(2-furanmethanol), 2,4:3,5-di-ortho-methylene-D-mannitol, tetrahydrofuran-2,5-dimethanol, or a mixture thereof. In this case, the diol component, other than cyclohexanedimethanol, may be included in an amount of 1 mol % to 20 mol %, based on the total 70 mol % to 99 mol % of the moieties of the total diol components.

The ethylene glycol is a component contributing to improving transparency and impact strength of the polyester copolymer prepared together with cyclohexanedimethanol.

The isosorbide is used to improve processability of the prepared polyester copolymer. Even though the transparency and impact strength of the polyester copolymer are improved by the diol component of cyclohexanedimethanol and ethylene glycol, the shear fluidization characteristics should be improved and the crystallization rate should be delayed for processability. However, it is difficult to achieve this effect by only cyclohexanedimethanol and ethylene glycol. Accordingly, when isosorbide is included as the diol component, the shear fluidization characteristics are improved and the crystallization rate is delayed while maintaining transparency and impact strength, thereby improving the processability of the prepared polyester copolymer.

### Diamine Component

With regard to the polyesteramide resin, the diamine component may be fed together with diacid component and the diol component at once. The diamine component corresponds to a main monomer that forms the polyesteramide resin through the amidation reaction with the diacid component and the polycondensation reaction.

Specifically, the diamine component includes bis(aminomethyl)cyclohexane (BAC), which is a compound having a molecular weight of 140 g/mol to 150 g/mol and a boiling point of 235° C. to 250° C., and the diamine component is a component contributing to improving heat resistance (particularly, thermal properties such as Tg, etc.) and film properties (particularly, properties such as tensile strength, storage modulus, etc.) of the polyesteramide resin.

The bis(aminomethyl)cyclohexane may include 1,3-bis(aminomethyl)cyclohexane (1,3-BAC), 1,4-bis(aminomethyl)cyclohexane (1,4-BAC), or a mixture thereof. For example, as bis(aminomethyl)cyclohexane, as in Example to be described later, 1,3-bis(aminomethyl)cyclohexane represented by Chemical Formula 1 or 1,4-bis(aminomethyl)cyclohexane represented by Chemical Formula 2 may be used.

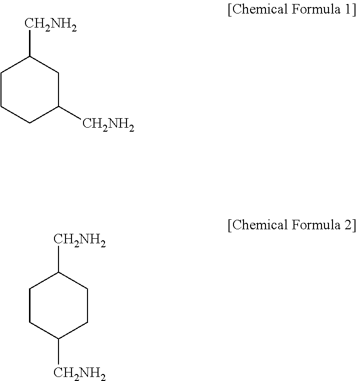

More specifically, the moiety derived from the diamine component in the polyesteramide resin may be included in an amount of 1 mol % to 30 mol %, based on 100 mol % of the diacid moiety.

When the content of the diamine moiety exceeds the above range, the content of the diol moiety is relatively reduced, and thus transparency and impact strength of the polyesteramide resin may become remarkably poor.

On the contrary, when the content of the diamine moiety is under the above range, its effect on the polyesteramide resin may be insignificant.

In contrast, when the content of the diamine moiety satisfies the above range, heat resistance and film properties of the polyesteramide resin may be improved. In addition, it is also possible to appropriately control the content of the diamine moiety by considering the desired physical properties of the polyesteramide resin.

For example, the diamine moiety in the polyesteramide resin may be included in an amount of 1 mol % or more, 1.5 mol % or more, 2 mol % or more, 2.5 mol % or more, or 3 mol % or more, and 30 mol % or less, 28 mol % or less, 26 mol % or less, 24 mol % or less, 22 mol % or less, or 20 mol % or less, based on 100 mol % of the diacid moiety.

In addition to bis(aminomethyl)cyclohexane, the diamine component may further include 4,4′-methylenebis(2-methylcyclohexylamine), 4,4′-methylenebis(cyclohexylamine), 1,4-tetramethylenediamine, 1,6-hexamethylenediamine, 2,4,5-trimethyl- 1,6-hexamethylenediamine, 5-amino-1,3,3-trimethylcyclohexanemethylamine, 1,4-bis(aminomethyl)cyclohexane, 2,2,4,4-tetramethyl-1,3-cyclobutanediamine, 1,3-cyclohexanediamine, 1,4-cyclohexanediamine, bi(cyclohexyl)-4,4′-diamine, 1,2-dicyclohexyl-1,2-ethanediamine, 1,3-xylylenediamine, 1,4-xylylenediamine or a mixture thereof. In this case, the diamine components other than bis(aminomethyl)cyclohexane may be included in an amount of 1 mol % to 10 mol %, based on the total 1 mol % to 30 mol % of the moieties of the total diamine components.

According to Example to be described later, the polyesteramide resin prepared by further including the diamine component is confirmed to have a remarkably high glass transition temperature (Tg) and zero shear viscosity (ZSV), as compared to a polyester resin prepared using the diacid component and the diol component.

Through this, it can be seen that the polyesteramide resin has the increased glass transition temperature, melt viscosity, and zero shear viscosity by the effect of additionally introducing the diamine moiety to the main chain, as compared to the polyester resin composed of the diacid moiety and the diol moiety.

Furthermore, according to Experimental Example to be described later, a biaxially oriented film manufactured using the polyesteramide resin was confirmed to have remarkably high glass transition temperature, and tensile strength, elongation, and modulus in each direction, as compared to a biaxially oriented film manufactured using the polyester resin.

Through this, it can be seen that the final biaxially oriented polyesteramide film becomes thick and has improved physical properties due to increased melt viscosity and process stability during an extraction process of forming the biaxially oriented film by the effect of additionally introducing the diamine moiety to the main chain, as compared to the polyester resin composed of the diacid moiety and the diol moiety.

Meanwhile, according to Experimental Example to be described later, it was confirmed that as the mol % of the diamine moiety in the polyesteramide resin increases, the glass transition temperature and cold crystallization temperature (Tcc) generally tend to increase, and the melting point (Tm), melt crystallization temperature (Tmc), intrinsic viscosity (IV), and zero shear viscosity generally tend to decrease.

In addition, according to Experimental Example to be described later, it was confirmed that as the mol % of the diamine moiety in the polyesteramide resin increases, the intrinsic viscosity and elongation of the biaxially oriented film tend to decrease, whereas the glass transition temperature, and tensile strength and modulus in each direction tend to increase, and the thickness of the film tends to increase.

In this regard, in consideration of the desired physical properties of the resin and film, the moiety composition in the polyesteramide resin may be adjusted within the above-described range. In addition, the moiety composition in the polyesteramide resin may be controlled by appropriately adjusting the monomer composition, as described above.

### Molar Contents of Moiety Components

As described above, the diol moiety may be included in an amount of 70 mol % to 99 mol %, and the diamine moiety may be included in an amount of 1 mol % to 30 mol %, based on 100 mol % of the diacid moiety in the polyesteramide resin. Within these ranges, the content of each moiety may be appropriately adjusted.

However, when the content of each moiety is adjusted, a molar ratio of the diacid moiety and the diol moiety needs to satisfy a specific range.

The diol moiety should satisfy 70 mol % to 99 mol %, based on 100 mol % of the diacid moiety.

When the diol moiety is included in excess over the above range, the content of the diamine moiety is relatively decreased, and as a result, heat resistance and film properties of the polyesteramide resin may be significantly poor.

On the contrary, when the content of the diol moiety is under the above range, the effect by the diol moiety may be insignificant.

In contrast, when the molar contents of the diacid moiety and the diol moiety satisfy the above ranges, the diacid moiety, the diol moiety, and the diamine moiety are blended to express a balanced effect, and thus heat resistance and film properties of the polyesteramide resin may be improved. Within the above range, it is also possible to appropriately adjust the molar contents of the diacid moiety and the diol moiety by considering the desired physical properties of the polyesteramide resin.

For example, the content of the diol moiety may be adjusted to 70 mol % to 99 mol %, 75 mol % to 98 mol %, or 80 mol % to 97 mol %, based on 100 mol % of the diacid moiety.

Meanwhile, the content of the diamine moiety may be 1 mol % to 30 mol %, based on 100 mol % of the diacid moiety.

Furthermore, the sum of the diol moiety and the diamine moiety may be a total of 100 mol %, based on 100 mol % of the diacid moiety. Here, 70 mol % to 99 mol % of the diol moiety and 1 mol % to 30 mol % of the diamine moiety may be included.

Within these ranges, as the mol % of the diamine moiety increases, the mol % of the diol moiety decreases, and the glass transition temperature and cold crystallization temperature generally tend to increase, and the melting point, melt crystallization temperature, intrinsic viscosity, and zero shear viscosity generally tend to decrease.

Considering this tendency, the mol% of the diol moiety and the diamine moiety may be adjusted.

For example, the mol % of the diamine moiety may be adjusted to 1 mol % to 30 mol %, 2 mol % to 25 mol %, or 3 mol % to 20 mol %, based on 100 mol % of the diacid moiety. Further, the mol % of the diol moiety may be adjusted to 70 mol % to 99 mol %, 75 mol % to 98 mol %, or 80 mol % to 97 mol %, based on 100 mol % of the diacid moiety.

### Physical Properties of Polyesteramide Resin

The polyesteramide resin retains mechanical strength, heat resistance, chemical resistance, etc. due to the diacid moiety, and retains transparency and impact strength due to the diol moiety, while having heat resistance (particularly, thermal properties such as Tg, etc.) and film properties (particularly, properties such as tensile strength, storage modulus, etc.) due to the diamine moiety.

Specifically, the polyesteramide resin may have a glass transition temperature (Tg) of 80° C. to 150° C., specifically 90° C. to 140° C.; a cold crystallization temperature (Tcc) of 120° C. to 200° C., specifically 130° C. to 190° C.; a melting point (Tm) of 240° C. to 300° C., specifically 250° C. to 290° C.; a melt crystallization temperature (Tmc) of 180° C. to 250° C., specifically 190° C. to 240° C.

Further, the polyesteramide resin may have an intrinsic viscosity (IV) of 0.40 dl/g to 1.20 dl/g, specifically 0.50 dl/g to 1.00 dl/g.

Further, the polyesteramide resin may have a zero shear viscosity at 290° C. of 300 Pa·s to 600 Pa·s, specifically 350 Pa·s to 550 Pa·s.

A method of measuring each of the physical properties is specified in Experimental Example to be described later.

### Method of Preparing Polyesteramide Resin

In another embodiment of the present invention, provided is a method of preparing the polyesteramide resin by feeding the diacid component and the diol component at a specific mixing ratio to a reactor at once with the diamine component and water, followed by copolymerizing.

Specifically, provided is a method of preparing the polyesteramide resin, the method including the steps of performing esterification and amidation reactions of a monomer mixture including the diacid component including terephthalic acid, the diol component including cyclohexanedimethanol, and the diamine component including bis(aminomethyl)cyclohexane (Step 1); and performing a polycondensation reaction of products of the esterification and amidation reactions (Step 2).

At this time, a molar ratio of the diol component to the diacid component in the monomer mixture satisfies 0.7 to 1.3.

Through this process, the above-described polyesteramide resin of one embodiment may be prepared.

The preparation method may be performed in a batch, semi-continuous, or continuous manner, and the esterification and amidation reactions (Step 1) and the polycondensation reaction (Step 2) may be performed under an inert gas atmosphere.

As needed, a solid-phase polymerization reaction may be subsequently performed. Specifically, after the polycondensation reaction (Step 2), the step of performing crystallization of the prepared polyesteramide resin (Step 3); and the step of performing a solid-phase polymerization of the crystallized polyesteramide resin (Step 4) may be further included.

Hereinafter, descriptions that overlap with the above descriptions are omitted, and each step of the method of preparing the polyesteramide resin will be described in detail.

### Preparation of Monomer Mixture

It is necessary that a molar ratio of the diol component to the diacid component in the monomer mixture is 0.7 to 1.3.

This is to prepare the polyesteramide resin including 70 mol % to 99 mol % of the diol moiety, based on 100 mol % of the diacid moiety.

However, the above range may be appropriately adjusted in consideration of the desired composition of the polyesteramide resin. For example, a molar ratio of the diol component to the diacid component may be adjusted to 0.7 to 1.3, 0.8 to 1.3, 0.9 to 1.3, or 1.0 to 1.3.

The monomer mixture may include 1 mol to 30 mol of the diamine component, based on 100 mol of the diacid component.

Specifically, a molar ratio of the diamine component to the diacid component may be 0.01 to 0.30.

However, the above range may be appropriately adjusted in consideration of the desired composition of the polyesteramide resin. For example, a molar ratio of the diamine component to the diacid component may be adjusted to 0.01 to 0.30, 0.02 to 0.25, or 0.03 to 0.20.

Meanwhile, water may be added to the monomer mixture including the diacid component, the diol component, and the diamine component, thereby preparing a slurry. In this case, the esterification and amidation reactions may be performed in the slurry.

When the slurry is prepared by adding water to the monomer mixture, fluidity and reactivity may be improved during the esterification and amidation reactions, as compared to the case where water is not added.

In particular, the amidation reaction includes a series of processes of forming a salt by an acid-base reaction between the diacid component and the diamine component during heating, and then generating water as a by-product resulting from the amidation of the salt when the temperature reaches the reaction temperature.

The diacid component and the diamine component may easily undergo the acid-base reaction to form the salt in the slurry with high fluidity due to addition of water, as compared to the case where water is not added.

Accordingly, both Tg and IV of the polyesteramide resin copolymerized in the water-added slurry may be increased, as compared to the case where water is not added.

The monomer mixture of the diacid component, the diol component, and the diamine component may be included in an amount of 60% by weight to 97% by weight, and water may be included in an amount of 3% by weight to 40% by weight, based on the total 100% by weight of the slurry.

### Esterification and Amidation Reactions

The esterification and amidation reactions may be performed in the presence of a catalyst. A variety of reaction catalysts of metals and organic compounds may be used.

The esterification and amidation reactions may be performed at a pressure of 0 kgf/cm² to 10.0 kgf/cm² and a temperature of 150° C. to 300° C.

The esterification and amidation reaction conditions may be appropriately adjusted according to specific properties of the polyesteramide resin to be prepared, the ratio of each component, or process conditions. For example, the esterification and amidation reaction conditions include a pressure of 0 kgf/cm² to 5.0 kgf/cm², more specifically, 0.1 kgf/cm² to 3.0 kgf/cm²; and a temperature of 200° C. to 290° C., more specifically, 220° C. to 280° C.

### Polycondensation Reaction

The polycondensation reaction may be performed by reacting the products of the esterification and amidation reactions at a temperature of 150° C. to 320° C. under reduced pressure of 600 Torr to 0.01 Torr for 1 hour to 24 hours.

Such a polycondensation reaction may be performed at a reaction temperature of 150° C. to 320° C., specifically, 200° C. to 300° C., and more specifically, 250° C. to 290° C. under reduced pressure of 600 Torr to 0.01 Torr, specifically, 200 Torr to 0.05 Torr, and more specifically, 100 Torr to 0.1 Torr.

By applying the reduced pressure conditions of the polycondensation reaction, cyclohexanedimethanol which is a major by-product of the polycondensation reaction may be removed out of the system. Thus, when the polycondensation reaction is performed outside the reduced pressure range of 400 Torr to 0.01 Torr, the removal of by-products may not be sufficient.

In addition, when the polycondensation reaction occurs outside the temperature range of 150° C. to 320° C., i.e., when the polycondensation reaction occurs at 150° C. or lower, cyclohexanedimethanol which is a major by-product of the polycondensation reaction may not be effectively removed out of the system, and thus the intrinsic viscosity of the final reaction product becomes low. Accordingly, the physical properties of the prepared polyesteramide resin may deteriorate. When the reaction occurs at 320° C. or higher, there is a high possibility that yellowing occurs on the appearance of the prepared polyesteramide resin.

The polycondensation reaction may be performed for a reaction time of 1 hour to 24 hours on average until the intrinsic viscosity of the final reaction product reaches a target level.

### Additives

A polycondensation catalyst, a stabilizer, a colorant, a crystallizing agent, an antioxidant, a branching agent, etc. may be added to the slurry before the start of the esterification and amidation reactions or to the reaction intermediate product.

However, the input timing of the additives is not limited thereto, and they may be added at any time point during the preparation of the polyesteramide resin.

As the polycondensation catalyst, one or more selected from common titanium, germanium, antimony, aluminum, tin-based compounds, etc. may be appropriately used.

The titanium-based catalyst may include tetraethyl titanate, acetyltripropyl titanate, tetrapropyl titanate, tetrabutyl titanate, polybutyl titanate, 2-ethylhexyl titanate, octylene glycol titanate, lactate titanate, triethanolamine titanate, acetyl acetonate titanate, ethyl acetoacetic ester titanate, isostearyl titanate, titanium dioxide, a titanium dioxide/silicon dioxide complex, a titanium dioxide/zirconium dioxide complex, etc.

Further, the germanium-based catalyst may include germanium dioxide and a complex using the same.

As the stabilizer, a phosphorus-based compound such as phosphoric acid, trimethyl phosphate, triethyl phosphate, etc. may be generally used, and the addition amount thereof may be 10 ppm to 500 ppm (based on elemental phosphorus), based on the weight of the final polyesteramide resin.

When the addition amount of the stabilizer is less than 10 ppm, the stabilization effect is insufficient, and it is apprehended that the color of the polymer turns yellow. When it exceeds 500 ppm, it is apprehended that a polyesteramide resin having a desired high degree of polymerization may not be obtained.

In addition, as the colorant added to improve the color of the polyesteramide resin, common colorants such as cobalt acetate, cobalt propionate, etc. may be exemplified, and the addition amount thereof may be 10 ppm to 200 ppm (based on elemental cobalt), based on the weight of the final polyesteramide resin.

As needed, an anthraquinone-based compound, a perinone-based compound, an azo-based compound, a methine-based compound, etc. may be used as an organic compound colorant. Commercially available products include Clarient' s toners such as Polysynthren Blue RLS, Solvaperm Red BB, etc. The addition amount of the organic compound colorant may be adjusted to 0 ppm to 50 ppm, based on the weight of the final polymer. When the colorant is used in an amount outside the above range, the yellowing of the polyesteramide resin may not be sufficiently covered or the physical properties may deteriorate.

As the crystallizing agent, a crystal nucleating agent, an ultraviolet absorber, a polyolefin-based resin, a polyamide resin, etc. may be exemplified.

As the antioxidant, a hindered phenol-based antioxidant, a phosphite-based antioxidant, a thioether-based antioxidant, or a mixture thereof may be exemplified.

The branching agent is a common branching agent having three or more functional groups, and may be exemplified by trimellitic anhydride, trimethylol propane, trimellitic acid, or mixtures thereof.

Further, in the polycondensation reaction, a polycondensation reaction catalyst including a titanium-based compound, a germanium-based compound, an antimony-based compound, an aluminum-based compound, a tin-based compound, or a mixture thereof may be used.

Examples of the titanium-based compound may include tetraethyl titanate, acetyltripropyl titanate, tetrapropyl titanate, tetrabutyl titanate, 2-ethylhexyl titanate, octylene glycol titanate, lactate titanate, triethanolamine titanate, acetylacetonate titanate, ethyl acetoacetic ester titanate, isostearyl titanate, titanium dioxide, etc. Examples of the germanium-based compound may include germanium dioxide, germanium tetrachloride, germanium ethylene glycol oxide, germanium acetate, complexes using the same, mixtures thereof, etc. Preferably, germanium dioxide may be used. As such germanium dioxide, any of crystalline and amorphous may be used, and glycol soluble may also be used.

### Biaxially Oriented Film

According to still another embodiment of the present invention, provided is a biaxially oriented film including the above-described polyesteramide resin of one embodiment.

Particularly, the biaxially oriented film has excellent heat resistance (particularly, thermal properties such as Tg, etc.) and film properties (particularly, properties such as tensile strength, storage modulus, etc.) due to the diamine moiety in the polyesteramide resin.

### Method of Manufacturing Biaxially Oriented Film

The biaxially oriented film may be manufactured by biaxially stretching the polyesteramide resin.

Specifically, the biaxially oriented film may be manufactured by the steps of melt-extruding the polyesteramide resin to manufacture an unstretched polyesteramide film including a resin layer formed from the polyesteramide resin; and biaxially stretching the unstretched polyesteramide film at a temperature higher than the glass transition temperature of the polyesteramide resin.

In the step of manufacturing the unstretched polyesteramide film, thermal decomposition of the polymer may be minimized by melt-extruding the polyesteramide resin at a temperature of Tm±30° C.

Specifically, the step of manufacturing the unstretched polyesteramide film may be performed at a temperature of 240° C. to 310° C., or 250° C. to 300° C.

When the melt extrusion temperature is lower than 240° C., the polymer may not melt, and when it is higher than 310° C., thermal decomposition of the polymer increases, and thus the film may be damaged or broken during stretch molding of the film, which makes it difficult to realize the desired physical properties.

The unstretched polyesteramide film may be cooled to an appropriate temperature. Thereafter, the unstretched polyesteramide film may be stretched at a temperature higher than the glass transition temperature of the polyesteramide resin.

The process of stretching the unstretched polyesteramide film is performed at a temperature of 80° C. to 200° C., specifically 90° C. to 190° C., more specifically 100° C. to 180° C., such that the unstretched polyesteramide film may be stretched at a high magnification.

Specifically, for biaxial stretching, the unstretched polyesteramide film may be stretched 2 times to 6 times, specifically, 2 times to 5 times in the machine direction (MD) of the unstretched polyesteramide film, and 2 times to 6 times, specifically, 2 times to 5 times in the transverse direction (TD) thereof.

More specifically, when the unstretched polyesteramide film is stretched, the product of the draw ratio in the machine direction and the draw ratio in the transverse direction may be 12 to 30.

After biaxially stretching the unstretched polyesteramide film, the step of heat setting may be further included in order to impart dimensional stability to the obtained biaxially oriented polyesteramide film.

The step of heat setting may be performed at a temperature of 80° C. to 250° C.

The thickness of the unstretched polyesteramide film may be 200 μm to 1000 μm, and the thickness of the biaxially stretched polyesteramide film may be 5 μm to 500 μm.

The biaxially oriented film may have a glass transition temperature (Tg, DMA) of 100° C. to 250° C., specifically, 100° C. to 200° C.; a tensile strength in the machine direction (MD) of 5 to 25 kgf/mm², specifically, 5 kgf/mm² to 20 kgf/mm²; a tensile strength in the transverse direction (TD) of 5 kgf/mm² to 35 kgf/mm², specifically, 5 kgf/mm² to 30 kgf/mm²; a modulus in the machine direction (MD) of 100 kgf/mm² to 400 kgf/mm², specifically, 100 kgf/mm² to 350 kgf/mm²; and a modulus in the transverse direction (TD) of 100 kgf/mm² to 500 kgf/mm², specifically, 100 kgf/mm² to 450 kgf/mm².

### EFFECT OF THE INVENTION

A polyesteramide resin of one embodiment may express the effects of a diacid moiety and a diol moiety in balance while expressing the effect of a diamine, thereby exhibiting excellent heat resistance (particularly, thermal properties such as Tg, etc.), as compared to polyester resins generally known.

Further, a biaxially oriented film including the polyesteramide resin of one embodiment may exhibit excellent properties (particularly, properties such as tensile strength, storage modulus, etc.), as compared to polyester resins generally known.

Furthermore, the polyesteramide resin of one embodiment may be prepared by copolymerizing the diacid component and the diol component blended at a specific molar ratio, together with the diamine component.

### DETAILED DESCRIPTION OF THE EMBODIMENTS

Hereinafter, preferred examples will be provided for better understanding of the present invention. However, the following examples are provided only for understanding the present invention more easily, but the content of the present invention is not limited thereby.

### Example 1

To a batch reactor with a capacity of 5 kg, 1,514 g of terephthalic acid (TPA), 1,855 g of 1,4-cyclohexanedimethanol (1,4-CHDM), 38.9 g of 1,3-bis(aminomethyl)cyclohexane (1,3-BAC), 186 g of water, 0.15 g of titanium oxide-based catalyst (Sachtleben), and 0.36 g of triethyl phosphate were fed. In this regard, a molar ratio of CHDM to TPA was 1.27, and water was included in an amount of 5.2% by weight, based on the total 100% by weight of a slurry including the monomer mixture and water.

After feeding the raw materials, esterification and amidation reactions (Step 1) were performed by applying a pressure of 1.0 kgf/cm², and heating to 280° C. for 3 hours. Then, a polycondensation reaction (Step 2) was performed by heating to 290° C. for 150 minutes under vacuum of 0.5 Torr to 1.0 Torr. Then, the final product was discharged in a strand to the outside of the reactor, and pelletized through a cooling tank, thereby preparing a polyesteramide resin.

### Example 2

To a batch reactor with a capacity of 5 kg, 1,514 g of TPA, 1,643 g of 1,4-CHDM, 64.8 g of 1,3-BAC, 164 g of water, 0.15 g of titanium oxide-based catalyst (Sachtleben), and 0.36 g of triethyl phosphate were fed. In this regard, a molar ratio of CHDM to TPA was 1.25, and water was included in an amount of 5.1% by weight in a slurry including the monomer mixture and water. Then, a polyesteramide resin was prepared in the same manner as in Example 1.

### Example 3

To a batch reactor with a capacity of 5 kg, 1,515 g of TPA, 1,578 g of 1,4-CHDM, 130 g of 1,3-BAC, 158 g of water, 0.15 g of titanium oxide-based catalyst (Sachtleben), and 0.36 g of triethyl phosphate were fed. In this regard, a molar ratio of CHDM to TPA was 1.20, and water was included in an amount of 4.9% by weight in a slurry including the monomer mixture and water. Then, a polyesteramide resin was prepared in the same manner as in Example 1.

### Example 4

To a batch reactor with a capacity of 5 kg, 1,516 g of TPA, 1,448 g of 1,4-CHDM, 260 g of 1,3-BAC, 145 g of water, 0.15 g of titanium oxide-based catalyst (Sachtleben), and 0.36 g of triethyl phosphate were fed. In this regard, a molar ratio of CHDM to TPA was 1.10, and water was included in an amount of 4.5% by weight in a slurry including the monomer mixture and water. Then, a polyesteramide resin was prepared in the same manner as in Example 1.

### Example 5

To a batch reactor with a capacity of 5 kg, 1,517 g of TPA, 1,463 g of 1,4-CHDM, 390 g of 1,4-bis(aminomethyl)cyclohexane (1,4-BAC), 146 g of water, 0.15 g of titanium oxide-based catalyst (Sachtleben), and 0.36 g of triethyl phosphate were fed. In this regard, a molar ratio of CHDM to TPA was 1.10, and water was included in an amount of 4.3% by weight in a slurry including the monomer mixture and water. Then, a polyesteramide resin was prepared in the same manner as in Example 1.

### Comparative Example 1

To a batch reactor with a capacity of 5 kg, 1,514 g of TPA, 1,708 g of 1,4-CHDM, 0.15 g of titanium oxide-based catalyst (Sachtleben), and 0.36 g of triethyl phosphate were fed. In this regard, a molar ratio of CHDM to TPA was 1.30. Then, a polyesteramide resin was prepared in the same manner as in Example 1.

### Comparative Examples 2 to 4

Polyester resins of Comparative Examples 2 to 4 were prepared in the same manner as in Comparative Example 1 according to each composition of TPA, IPA, 1,4-CHDM, and EG in Table 2 below, respectively.

### Comparative Example 5

To a batch reactor with a capacity of 5 kg, 1,517 g of TPA, 1,976 g of 1,4-CHDM, 390 g of 1,4-BAC, 0.15 g of titanium oxide-based catalyst (Sachtleben), and 0.36 g of triethyl phosphate were fed. In this regard, a molar ratio of CHDM to TPA was 1.50, and water was not added to a slurry of the monomer mixture. Then, a polyesteramide resin was prepared in the same manner as in Example 1.

### Experimental Example 1: Physical Properties of Resin

Physical properties of the resin samples of Examples 1 to 5 and Comparative Examples 1 to 5 were tested by the following method, and the test results are shown in Tables 1 to 3 below.

### 1) Moiety Composition of Final Product

The moiety composition (mol %) included in each of the resin samples of Examples 1 to 4 and Comparative Examples 1 to 4 was examined by IH-NMR spectrum obtained at 25° C. using a nuclear magnetic resonance (JEOL, 600 MHz FT-NMR) after dissolving the sample at a concentration of 3 mg/mL in a CDCl₃ solvent

### 2) Thermal Properties: Glass Transition Temperature (Tg), Cold Crystallization Temperature (Tcc), Melting Point (Tm), and Melt Crystallization Temperature (Tmc)

Thermal properties of each of the compounds of Examples 1 to 5 and Comparative Examples 1 to 5 were tested using differential scanning calorimetry (DSC).

Specifically, the resin sample was placed in an aluminum pan, and heated from 30° C. to 320° C. at a rate of 10° C./min, hold at 320° C. for 2 minutes, and then cooled to 30° C. at −150° C./min. Subsequently, an endothermic curve was obtained, when heated to 320° C. at a rate of 10° C./min.

From the endothermic curve, Tg, Tcc, and Tm were determined. Subsequently, the temperature was hold at 320° C. for 2 minutes, and then an exothermic curve was obtained when cooled to 30° C. at a rate of −10° C./min. From this exothermic curve, Tmc was determined.

### 3) Intrinsic Viscosity (IV)

The resin sample was dissolved at a concentration of 1.2 g/dl in orthochlorophenol at 150° C., and then the intrinsic viscosity was measured using an Ubbelohde viscometer.

The temperature of the viscometer was maintained at 35° C., and when the time (efflux time) taken for the solvent to pass between sections a-b inside the viscometer was regarded as t, and the time taken for the solution to pass therebetween was regarded as T₀, the specific viscosity was defined as follows. At this time, the intrinsic viscosity was obtained using the following correction equation.

$${η}_{sp} = \frac{t - {t}_{0}}{{t}_{0}}$$

In this regard, A is a Huggins constant, 0.247, and c is a concentration value of 1.2 g/dl.

$$[ η ] = \frac{\sqrt{1 + 4 A {η}_{zp}} - 1}{2 Ac}$$

### 4) Zero Shear Viscosity (ZSV)

Zero shear viscosity of each of the resins of Examples 1 to 4 and Comparative Examples 1 to 4 was measured using a parallel plate rheometer.

Specifically, with respect to the resin sample, the zero shear viscosity value of the complex viscosity obtained by measuring at angular frequency of 0.1 rad/s to 500 rad/s at 290° C. was taken.

TABLE 1

| | | | Example | | | |
|---|---|---|---|---|---|---|
| Section | Item | Unit | 1 | 2 | 3 | 4 |
| Moiety | TPA | mol % | 100 | 100 | 100 | 100 |
| composition | 1,4-CHDM | mol % | 97 | 95 | 90 | 80 |
| | 1,3-BAC | mol % | 3 | 5 | 10 | 20 |
| Physical | Tg | ° C. | 94 | 97 | 102 | 113 |
| properties of | Tcc | ° C. | 140 | 147 | 164 | 176 |
| resin | Tm | ° C. | 282 | 278 | 271 | 257 |
| | Tmc | ° C. | 223 | 218 | 200 | 216 |
| | IV | dl/g | 0.79 | 0.76 | 0.71 | 0.65 |
| | ZSV(290° C.) | Pa · s | 481 | 463 | 466 | 377 |

TABLE 2

| | | | Comparative Example | | | |
|---|---|---|---|---|---|---|
| Section | Item | Unit | 1 | 2 | 3 | 4 |
| Moiety | TPA | mol % | 100 | 95 | 88 | 100 |
| composition | IPA | mol % | — | 5 | 12 | — |
| | 1,4-CHDM | mol % | 100 | 100 | 100 | 90 |
| | EG | mol % | — | — | — | 10 |
| Physical | Tg | ° C. | 90 | 89 | 89 | 88 |
| properties of | Tcc | ° C. | 130 | 133 | 140 | 139 |
| resin | Tm | ° C. | 288 | 280 | 268 | 272 |
| | Tmc | ° C. | 245 | 216 | 198 | 222 |
| | IV | dl/g | 0.79 | 0.73 | 0.76 | 0.77 |
| | ZSV(290° C.) | Pa · s | — | 279 | 294 | — |

TABLE 3

| | | | | Comparative |
|---|---|---|---|---|
| | | | Example | Example |
| Section | Item | Item | 5 | 5 |
| Feed composition | TPA | mol | 100 | 100 |
| | 1,4-CHDM | mol | 100 | 150 |
| | 1,4-BAC | mol | 30 | 30 |
| Slurry | Water | wt % | 4.3 | — |
| Physical properties | Tg | ° C. | 122 | 110 |
| of resin | Tcc | ° C. | 172 | 176 |
| | Tm | ° C. | 268 | 270 |
| | Tmc | ° C. | 206 | 208 |
| | IV | dl/g | 0.58 | 0.40 |

According to Tables 1 and 2, in terms of melting point (Tm), cold crystallization temperature (Tcc), melt crystallization temperature (Tmc), and intrinsic viscosity (IV), the polyesteramide resins of Examples 1 to 4 were almost the same as those of the polyester resins of Comparative Examples 1 to 4.

However, the polyesteramide resins of Examples 1 to 4 showed remarkably high glass transition temperature (Tg) and zero shear viscosity (ZSV), as compared to the polyester resins of Comparative Examples 1 to 4.

These results indicate that the glass transition temperature, melt viscosity, and zero shear viscosity of the polyesteramide resins were increased due to introduction of the diamine moiety to the main chain, as compared to the polyester resins composed of the diacid moiety and diol moiety.

Meanwhile, according to Table 1, as the content of the diamine moiety in the polyesteramide resins of Examples 1 to 4 increases, Tg and Tcc generally tend to increase, and Tm, Tmc, IV, and ZSV generally tend to decrease.

In this regard, in consideration of the desired physical properties of the resin, it is possible to adjust the moiety composition in the polyesteramide resin within the scope of the above-described embodiment. In addition, the moiety composition in the polyesteramide resin may be controlled by appropriately adjusting the monomer composition, as described above.

In addition, according to Table 3, both Tg and IV of the polyesteramide resin of Example 5 were high, as compared to those of the polyesteramide resin of Comparative Example 5.

Specifically, the diacid component and the diamine component may easily undergo the acid-base reaction to form a salt in the slurry with high fluidity due to addition of water, as compared to the case where water is not added. This indicates that the amidation reaction may easily occur in the slurry to which water is added, as compared to the case where water is not added. As a result, the polyesteramide resin having both high Tg and IV could be prepared in Example 5, as compared to Comparative Example 5.

### Experimental Example 2: Physical Properties of Biaxially Oriented Film

### (1) Manufacture of Biaxially Oriented Film

Each biaxially oriented film was prepared using the polyesteramide resins of Examples 2 and 3 and the polyester resin of Comparative Example 2.

Specifically, the resin chip was melted at a temperature of 280° C. to 290° C. in an extruder.

The melt was extruded through a die, molded into a sheet, and quenched. The sheet thus obtained was stretched 3.0 times in the machine direction (MD) and then 3.7 times in the transverse direction (TD). In order to impart dimensional stability to the stretched film, heat-setting was performed at 220° C. under tension to obtain a biaxially oriented film.

### (2) Test of Physical Properties of Biaxially Oriented Film

Physical properties of the biaxially oriented films of Examples 2 and 3 and the biaxially oriented film of Comparative Example 2 were tested by the following methods, respectively, and the test results are shown in Table 4 below.

### 1) Intrinsic Viscosity (IV)

Intrinsic viscosity was tested in the same manner as in Experimental Example 1.

2) Glass transition Temperature (Tg)

The biaxially oriented films of Examples 2 and 3 and the biaxially oriented film of Comparative Example 2 were cut to a width of 5.3 mm and a length of about 40 mm, respectively, and dynamic mechanical analysis (DMA) was used to determine Tg of the film from the peak maximum in tan δ measured at a frequency of 1 hz by heating from 30° C. to 180° C. at a heating rate of 3° C./min.

### 3) Tensile Strength, Elongation, and Storage Modulus

Using a universal testing machine UTM 5566A (Instron), a sample with a length of 5 cm or more and a width of 1.5 cm in the MD and TD directions of the sample was mounted on a clip with a spacing of 5 cm, and then a stress-strain curve was obtained by stretching the sample at 200 mm/min at room temperature until a break occurred.

The force at the point where the sample was broken was taken as tensile strength, the length to be stretched was taken as elongation, and the slope of the load to the initial deformation was taken as storage modulus.

### 4) Thickness

5 points were measured in the width direction using a thickness tester (Labthink, Inc.), and an average value was determined as thickness.

TABLE 4

| | | | | | | Comparative | |
|---|---|---|---|---|---|---|---|
| | | Example 2 | | Example 3 | | Example 2 | |
| Item | Unit | MD | TD | MD | TD | MD | TD |
| IV | dl/g | 0.768 | | 0.659 | | 0.747 | |
| Tg(DMA) | ° C. | 135 | | 142 | | 125 | |
| Tensile strength | kgf/mm² | 9.8 | 12.8 | 10.7 | 12.8 | 6.7 | 6.8 |
| Elongation | % | 126 | 55 | 83 | 26 | 69 | 162 |
| Modulus | kgf/mm² | 184 | 214 | 216 | 262 | 184 | 163 |

| | | | | |
|---|---|---|---|---|
| Thickness | μm | 38 | 44 | 18~32 |

According to Table 4, the biaxially oriented polyesteramide film was found to have the high Tg, the high tensile strength, elongation, and modulus in each direction, and the uniform thickness, as compared to the biaxially oriented polyester film.

Specifically, in terms of IV, the biaxially oriented polyesteramide films of Examples 2 and 3 were almost the same as the polyester film of Comparative Example 2.

However, in terms of Tg, as well as the tensile strength, elongation, and modulus in each direction, the biaxially oriented polyesteramide films of Examples 2 and 3 were significantly higher than the polyester film of Comparative Example 2.

These results indicate that melt viscosity and process stability were increased due to the introduction of the diamine moiety to the main chain in the extrusion process for manufacturing the biaxially oriented film of the polyesteramide resin, and thus thickness of the final biaxially oriented polyesteramide film became uniform and various physical properties were improved, as compared to the polyester resin composed of the diacid moiety and the diol moiety.

On the other hand, as the molar content of the diamine moiety in the polyesteramide resins of Examples 2 and 3 increases, IV and elongation of the biaxially oriented film tend to decrease, whereas Tg and tensile strength and modulus in each direction tend to increase, and the film thickness tends to increase.

In this regard, in consideration of the desired physical properties of the film, it is possible to adjust the moiety composition in the polyesteramide resin within the scope of the above-described embodiment. In addition, the moiety composition in the polyesteramide resin may be controlled by appropriately adjusting the monomer composition, as described above.

What is claimed is:

1. A polyesteramide resin comprising:
a diacid moiety which is a moiety of a diacid component including terephthalic acid;
a diol moiety which is a moiety of a diol component including cyclohexanedimethanol; and
a diamine moiety which is a moiety of a diamine component including bis(aminomethyl)cyclohexane,
wherein the diol moiety is included in an amount of 70 mol % to 99 mol %, based on 100 mol % of the diacid moiety.

2. The polyesteramide resin of claim 1, wherein the cyclohexanedimethanol includes one or more selected from the group consisting of 1,2-cyclohexanedimethanol, 1,3-cyclohexanedimethanol, and 1,4-cyclohexanedimethanol.

3. The polyesteramide resin of claim 1, wherein the diol component further includes ethylene glycol, isosorbide, 1,3-cyclobutanediol, 2,4-dimethylcyclobutane-1,3-diol, 2,4-diethylcyclobutane-1,3-diol, 2,2-dimethylcyclobutane-1,3-diol, 2,2,4,4-tetramethylcyclobutane-1,3-diol, tricyclodecanedimethanol, pentacyclopentadecanedimethanol, decalindimethanol, tricyclotetradecanedimethanol, norbornanedimethanol, adamantanedimethanol, 3,9-bis(1,1-dimethyl-2-hydroxyethyl)-2,4,8,10-tetraoxaspiro[5.5]undecane, bicyclo[2.2.2]octane-2,3-dimethanol, 1,3-cyclohexanediol, 1,4-cyclohexanediol, 2-methyl-1,4-cyclohexanediol, tricyclodecanediol, pentacyclopentadecanediol, decalindiol, tricyclotetradecanediol, norbornanediol, adamantanediol, 2,2-bis(4-hydroxycyclohexyl)propane, 3,3′-spiro-bis(1,1-dimethyl-2,3-dihydro-1H-inden-5-ol), dispiro[5.1.5.1]tetradecane-7,14-diol, 5,5′-(1-methylethylidene)bis(2-furanmethanol), 2,4:3,5-di-ortho-methylene-D-mannitol, tetrahydrofuran-2,5-dimethanol, or a mixture thereof.

4. The polyesteramide resin of claim 1, wherein the bis(aminomethyl)cyclohexane includes 1,3-bis(aminomethyl)cyclohexane, 1,4-bis(aminomethyl)cyclohexane, or a mixture thereof.

5. The polyesteramide resin of claim 1, wherein the diamine component further includes 4,4′-methylenebis(2-methylcyclohexylamine), 4,4′-methylenebis(cyclohexylamine), 1,4-tetramethylenediamine, 1,6-hexamethylenediamine, 2,4,5-trimethyl-1,6-hexamethylenediamine, 5-amino-1,3,3-trimethylcyclohexanemethylamine, 1,4-bis(aminomethyl)cyclohexane, 2,2,4,4-tetramethyl-1,3-cyclobutanediamine, 1,3-cyclohexanediamine, 1,4-cyclohexanediamine, bi(cyclohexyl)-4,4′-diamine, 1,2-dicyclohexyl-1,2-ethanediamine, 1,3-xylylenediamine, 1,4-xylylenediamine, or a mixture thereof.

6. The polyesteramide resin of claim 1, wherein the diamine moiety is included in an amount of 1 mol % to 30 mol %, based on 100 mol % of the diacid moiety.

7. The polyesteramide resin of claim 1, wherein the polyesteramide resin has a glass transition temperature (Tg) of 80° C. to 150° C.

8. The polyesteramide resin of claim 1, wherein the polyesteramide resin has a cold crystallization temperature (Tcc) of 120° C. to 200° C.

9. The polyesteramide resin of claim 1, wherein the polyesteramide resin has a melting point (Tm) of 240° C. to 300° C.

10. The polyesteramide resin of claim 1, wherein the polyesteramide resin has a melt crystallization temperature (Tmc) of 180° C. to 250° C.

11. The polyesteramide resin of claim 1, wherein the polyesteramide resin has an intrinsic viscosity (IV) of 0.40 dl/g to 1.20 dl/g.

12. A method of preparing a polyesteramide resin, the method comprising the steps of:
performing esterification and amidation reactions of a monomer mixture including a diacid component including terephthalic acid, a diol component including cyclohexanedimethanol, and a diamine component including bis(aminomethyl)cyclohexane; and
performing a polycondensation reaction of products of the esterification and amidation reactions,
wherein a molar ratio of the diol component to the diacid component in the monomer mixture is 0.7 to 1.3.

13. The method of claim 12, wherein the monomer mixture includes 1 mol to 30 mol of the diamine component, based on 100 mol of the diacid component.

14. The method of claim 12, comprising the step of preparing a slurry including the monomer mixture and water, before esterification and amidation reactions,
wherein the esterification and amidation reactions are performed in the slurry.

15. The method of claim 14, wherein the monomer mixture is included in an amount of 60% by weight to 97% by weight, and water is included in an amount of 3% by weight to 40% by weight, based on the total 100% by weight of the slurry.

16. The method of claim 12, wherein the esterification and amidation reactions are performed in the presence of a phosphorus-based stabilizer.

17. The method of claim 12, wherein the polycondensation reaction is performed in the presence of a polycondensation catalyst of a titanium-based compound, a germanium-based compound, an antimony-based compound, an aluminum-based compound, a tin-based compounds, or a mixture thereof.

18. A biaxially oriented film comprising the polyesteramide resin of claim 1.

19. The biaxially oriented film of claim 18, wherein the biaxially oriented film is stretched 2 times to 6 times in the machine direction (MD), and 2 times to 6 times in the transverse direction (TD).

20. A biaxially oriented film comprising the polyesteramide resin of claim 2.
